(19) United States
(12) Patent Application Publication
(10) Pub. No.: US 2013/0344463 A1
(43) Pub. Date: Dec. 26, 2013

(54) International Celeration Project

(71) Applicant: Kevin Anthony Loewen, Hanford, CA (US)

(72) Inventor: Kevin Anthony Loewen, Hanford, CA (US)

(21) Appl. No.: 13/533,554

(22) Filed: Jun. 26, 2012

(51) Int. Cl. G09B 19/00

(52) U.S. Cl. 434/236

(57) ABSTRACT

A computer program designed to teach: a type of data collection through charting; provide the medium which continual charting for various purposes can be collected and modified via internet or standalone on various operating system platforms and; provide for personalization of certain chart-specific functionality features and of non-chart functional features. The specific form of charting is known as Celeration charting—charting that relies on rate of responding and semi- and/or logarithmic scaling. The teaching aspect of this application incorporates various tools and tutorials to advance accurate data collection for Celeration charting. Internet use will afford a medium of remote data storage and ease of updating program software and/or communication with others utilizing these tools. Personalization tools within the program makes this a living technology that is equipped to match the needs and desires of individual users.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

### Field of the Invention

The present invention relates generally to a charting method and chart commonly referred to as Celeration Charting and Celeration Charts—a technology and tool made relevant through Behavior Analysts and Applied Behavior Analysis. The present invention also relates to computer-assisted teaching methods, whereby a learner utilizes some form of electronic media to interface with the teaching modules and/or the application for general use. The present invention also relates to a communication network (e.g., Internet or Website) that provides the materials, updates, storage, and other related activities as a means to conduct celeration charting and analyses.

Current methods for teaching and using celeration charts are commonly performed via an instructor or self-taught through trial and error. Additionally, no automated teaching system has been reliably presented. Rather, paper and pencil have been the primary tools for those utilizing celeration charts. A more effective and efficient means for teaching and utilizing celeration charts is offered through this invention. Furthermore, the personalization aspect of this invention may increase user acceptability of the technology.

The prevalence of electronic application to aide in teaching have proven their efficacy. Additionally, an automated system of teaching will correct for omissions and errors present in human teaching situations.

There are concerns over the reliance on paper and pencil for data collection and charting. Charting errors may go unnoticed whereas an automated system can identify anomalies and make suggestions or request confirmation of data entry. Current celeration charting must be copied, transferred and converted to digital form for presentation. The present invention will correct for both of these shortcomings related to current celeration charting practices. Input of data will not come in multiple forms: (1) data/text entry into receptive fields and/or spreadsheets, (2) standard personal computer mouse point-and-click data entry, (3) touch-type and/or stylus entry such as that found in computer tablet technology and, (4) scan and conversion of pencil and paper data into digital data.

The present invention incorporates the mathematical computation capabilities for automatic calculation of user errors, correction prompting and/or automatic correction, data input and parameters to transfer onto presentation pages, data input and parameters to statistical calculations and presentation, data input and parameters into trends and projections and/or probability, and all other data input and parameters to accurately chart in this format. The present invention affords users personalization of charting tools and features as well as the opportunity to perform work related and relevant to their charting needs.

### BRIEF SUMMARY OF THE INVENTION

An electronic/digital application (e.g., computer program) designed to teach a type of data collection through charting, and/or provide the medium from which continual charting for various purposes can be collected and modified via internet or standalone on various operating system platforms, and to provide for personalization of certain chart-specific functionality features as well as personalization of non-chart functional features for the regular use of the application(s). The specific form of charting is known as celeration charting—a form of charting that relies on rate of responding and semi- and/or logarithmic scaling. The teaching aspect of this application incorporates various tools and tutorials to advance accurate data collection for celeration charting. Internet, or website, use will afford a medium of remote data storage and ease of updating program software and/or communication with others utilizing these tools and the invention. Personalization of the charting tools within the program makes this a living technology that is equipped to match the needs of individual users. Personalization of non-chart features and tools is primarily of the artistic sort. This invention will be made through computer programming across various operating system platforms and for various devices.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Non-limiting and non-exhaustive depictions and embodiments of the present invention are described. Reference to the following figures will be numerical and refer to like parts throughout the various depictions unless otherwise specified

FIG. 1. An embodiment of the logarithmic chart for daily per minute data collection. A basic element from which data may be collected upon, presented, analyzed, taught to learners, and other uses.

FIG. 2. An embodiment of the logarithmic chart for timings per minute data collection. A basic element from which data may be collected upon, presented, analyzed, taught to learners, and other uses.

FIG. 3. An embodiment of the logarithmic chart for timings per minute data collection that can be made to look like classical pencil and paper data collection.

FIG. 4. An embodiment of the logarithmic chart for daily per minute data collection that can be made to look like a digital presentation, or sterile, rather than pencil and paper data collection. In addition, other non-functional personalization attributes are displayed in this embodiment with the naming of the chart and other graphical additions (i.e., a flower).

FIG. 5 and FIG. 6. Embodiments of standard celeration tools for measuring actual accelerating or decelerating responding by visual analysis. Such a tool may overlay data lines or data trend lines to garner an approximation of celeration.

FIG. 7. Embodiments of standard celeration charting labels. For this embodiment only the date is depicted. Many other chart labels, with options for personalization both in font, display location, or otherwise, will be available.

FIG. 8. An embodiment of the logarithmic chart for daily per minute data collection that is viewed in a classical personal computer operating system window, or pane. User options for functional and non-functional personalization are available (i.e., file, edit, etc.).

FIG. 9. A non-exhaustive embodiment of the user options for functional and non-functional personalization are depicted here. Users of this invention will interface with the program features, settings, and options under similar headings of other common programs or headings and topics that are relevant for the optimal use of the invention.

FIG. 10. An embodiment of the logarithmic chart for daily per minute data collection that is viewed in a tablet window, or pane. Maximum use of viewing window will be made. The asterisk depicted in this embodiment is intended to signify a location(s) that the user may touch or tap with their finger or stylus to access a menu of user options. Otherwise, menu access may be made by keys or buttons on the device from which the invention is utilized.

FIG. 11. An embodiment of the logarithmic chart for daily per minute data collection that is viewed in a tablet window, or pane, and the location(s) that the user may touch or tap with their finger or stylus to access a menu of user options. Otherwise, menu access may be made by keys or buttons on the device from which the invention is utilized.

FIG. 12-FIG. 15. An embodiment of logarithmic charts and data input and/or computations in which the relevant multiple charts or spreadsheets are made viewable simultaneously for the user to assess, analyze, present, or for other uses.

FIG. 16. An embodiment of user interfacing with a touch screen to enhance or reduce the viewing of logarithmic charts and/or other data input spreadsheets, analyses, presentations, or for other uses. The two-finger motion depicted is not intended to be exhaustive, rather only an example of touch-screen user interfacing which is entirely dependent on the support and features of the device and operating system that the invention is used on.

FIG. 17. An embodiment of invention prompting learner or user for relevant information for accurate data collection.

FIG. 18. An embodiment of invention prompting learner or user for relevant information for accurate data collection and feedback of “correct” performance.

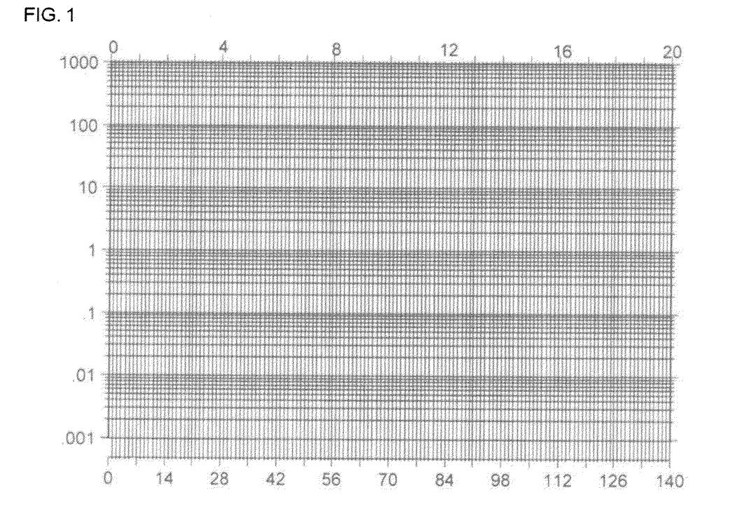

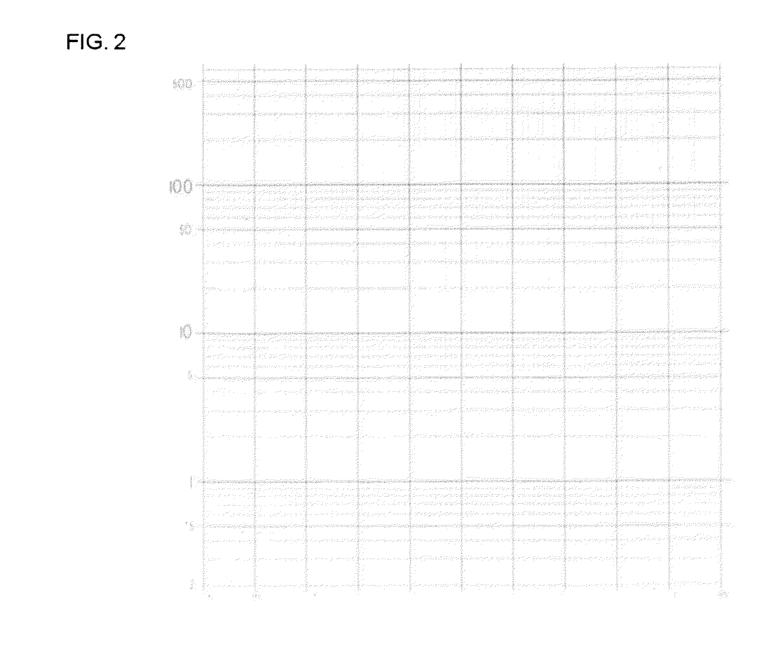

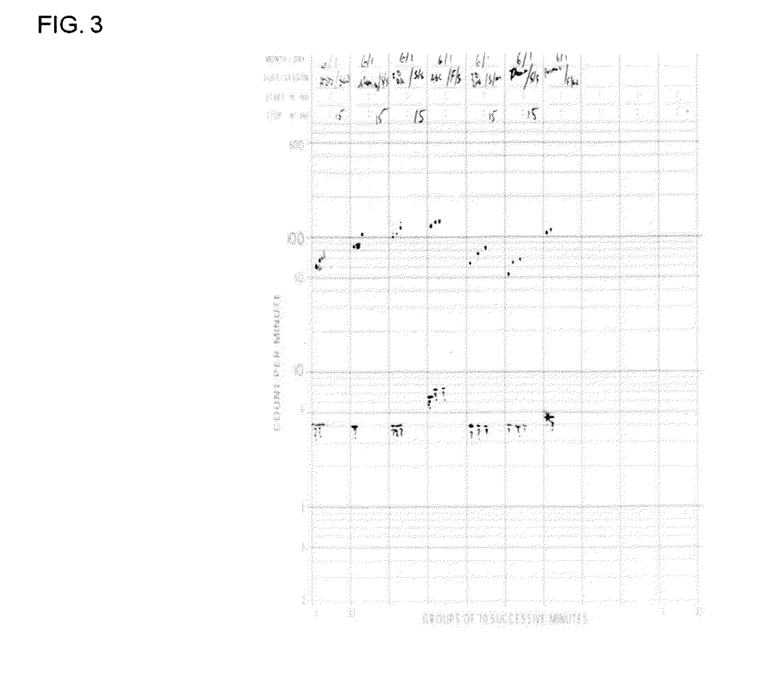

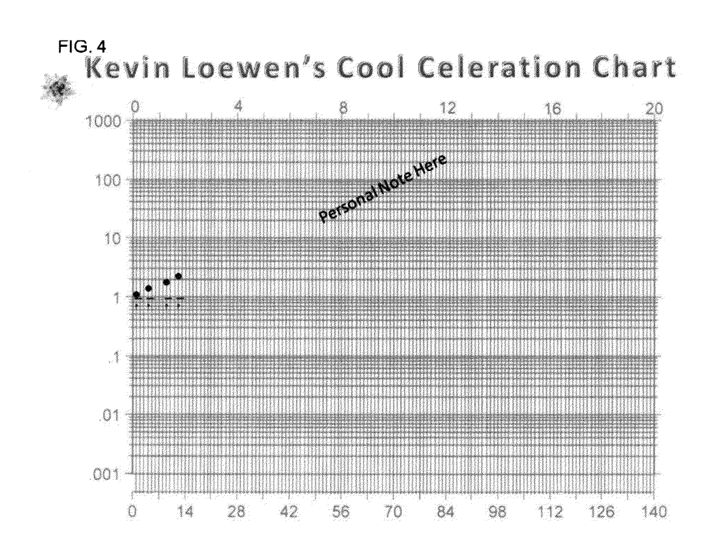

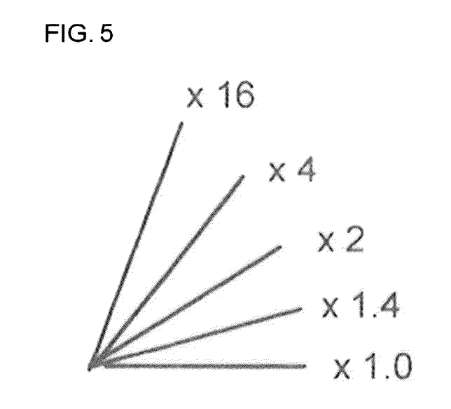

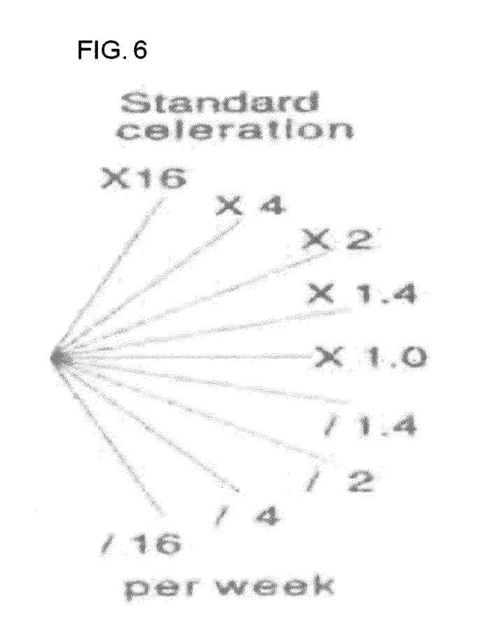

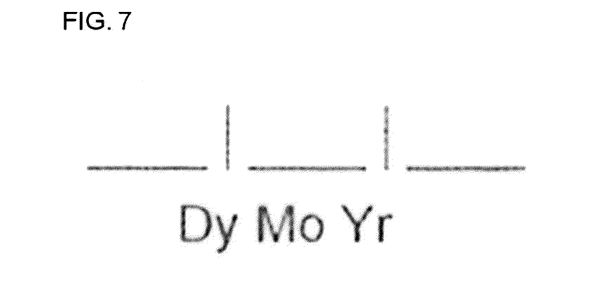

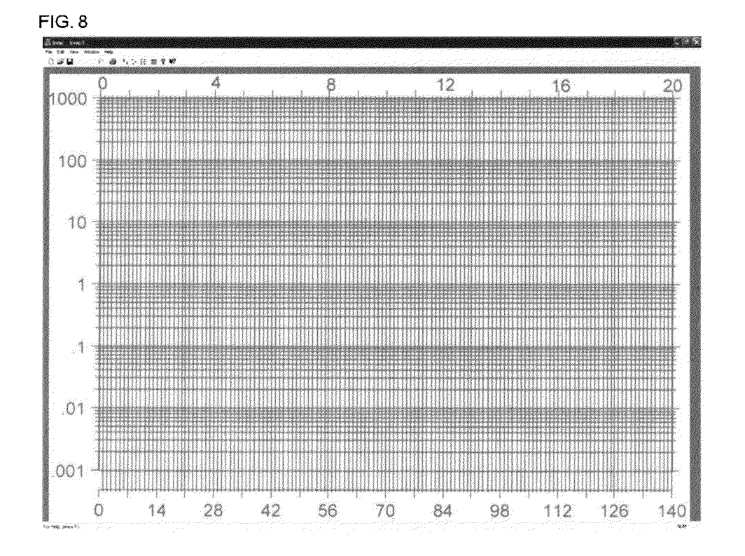

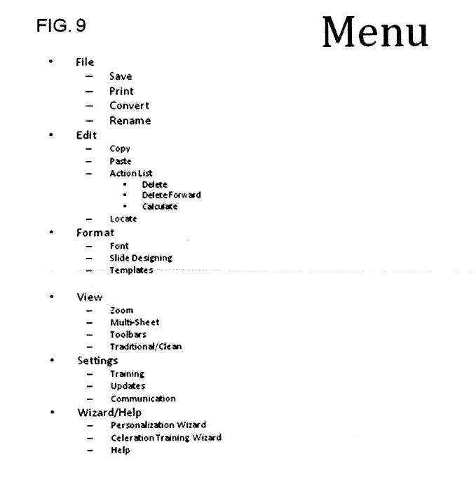

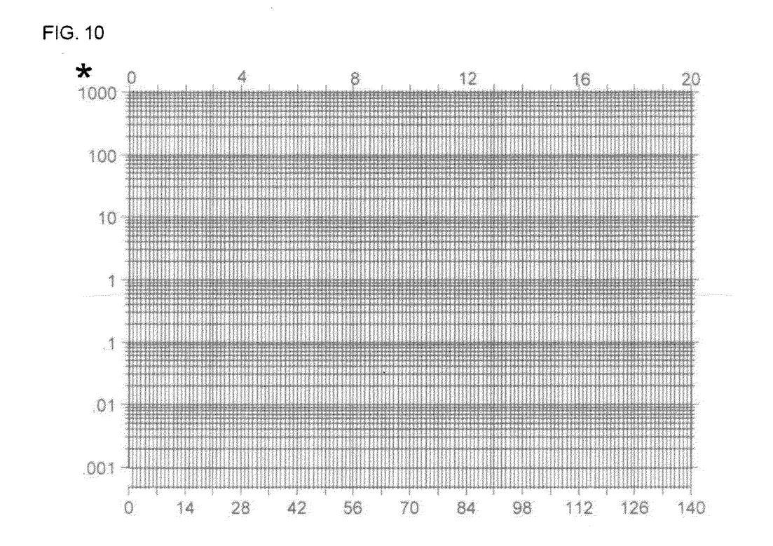

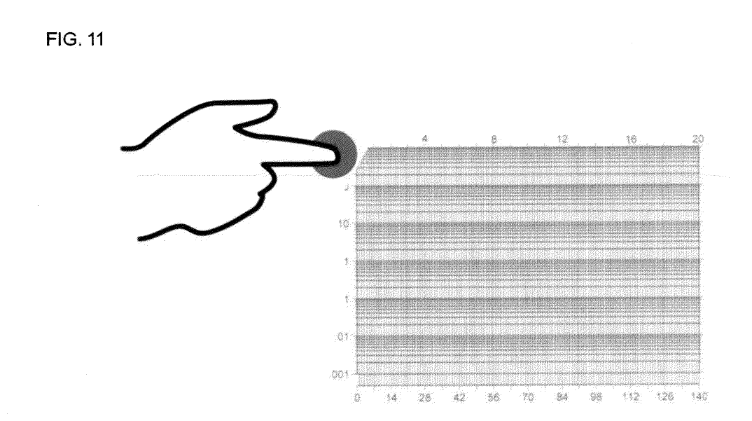

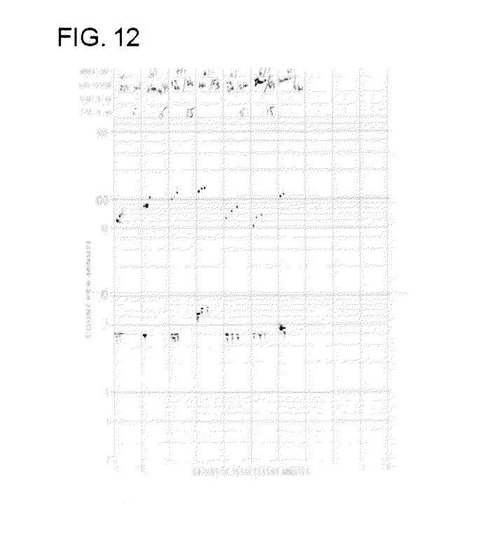

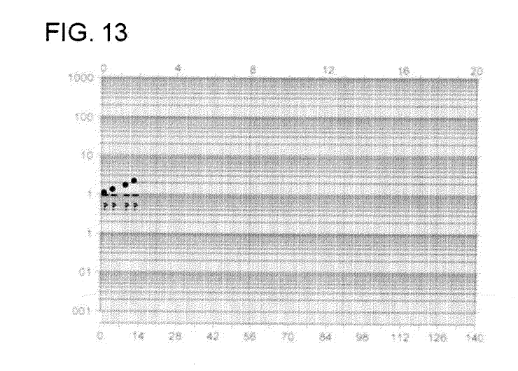

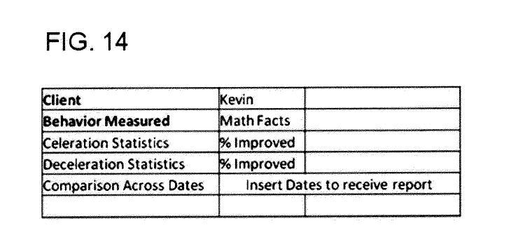

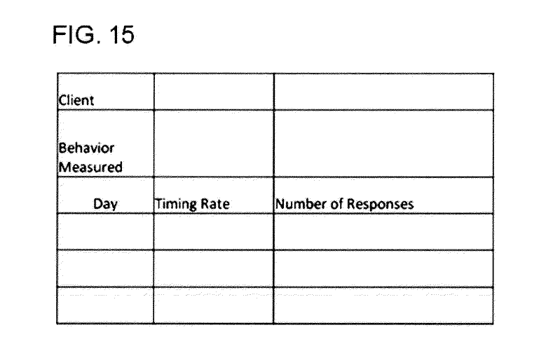

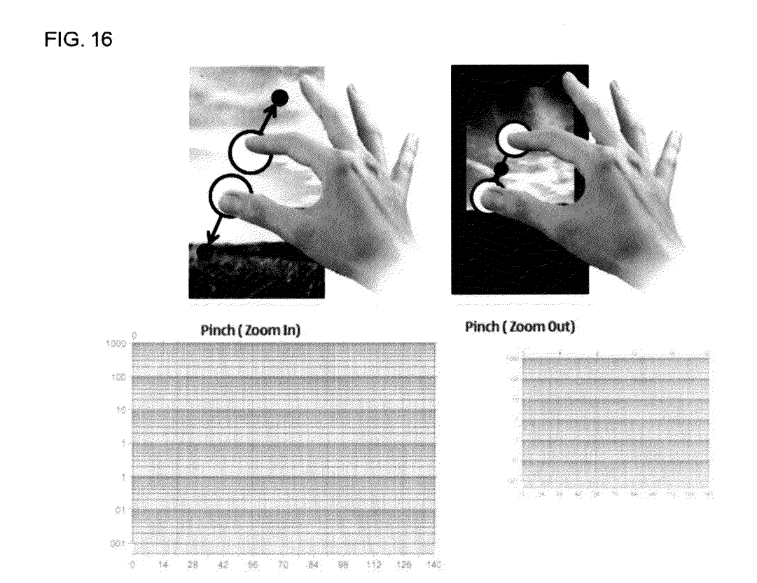

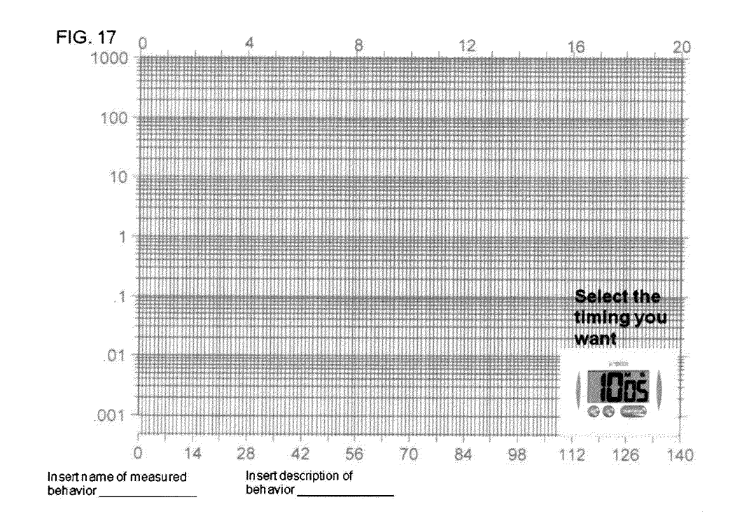

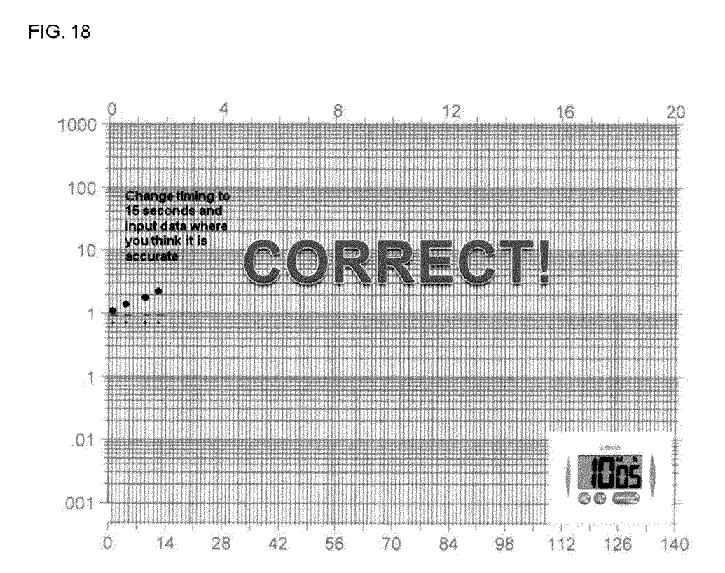

### DETAILED DESCRIPTION OF THE ILLUSTRATED EMBODIMENTS AND INVENTION

Embodiments of a system to teach skills, such as celeration charting, and to provide the use of the same learned technology to people of all ages are described herein. In this description some specific details are provided to provide a general understanding of embodiments of this invention. The embodiments provided herein are not intended to be exact final products of the invention, rather they are an example of important general aspects, which should be generalized to encumber all necessary details to perform the basic and advanced functions described above. Well-known structures, operations, and materials are not depicted or described in detail to avoid limiting or obscuring aspects of the invention.

Reference to an “embodiment” means that a particular feature, function, structure, operation, interface, or characteristic described in connection with the embodiment is included in at least one embodiment of the present invention. Thus, references to an embodiment throughout this specification may be referring to an overarching embodiment or its aggregates. The particular features, functions, structures, operations, interfaces, or characteristics may be combined in any suitable manner across embodiments.

The overarching features of the embodiments of the invention include procedures and routines to teach all aspects of celeration charting through an automated program, and provide for the continuous charting of the same technology across electronic/digital mediums. The embodiment of the invention implements technology that can be utilized via stand-alone electronic devices and across or implemented via a computer network such as the Internet.

The teaching aspect of the invention, as depicted in the embodiment, provides the necessary background information of celeration charting, the accurate methods for charting, recording of learner progress, and provision of the necessary proof of completion of training and performance. Visual, auditory, haptic, or other feedback will prompt learners for correct responses, advise of errors made, and praise for fluency of the technology. Teaching will consist of examples given and the requirement of the learner to perform in the same manner across multiple trials. The importance of this aspect of the invention lies in the computer aided automatic nature of the teaching aspect.

The continual use of the celeration charting program is provided in the form of a program that captures all necessary functions to perform celeration charting, analyses, computations, and presentation. Embodiments depict the basic feature of celeration charting with additional components such as: availability for use on electronic devices; use and storage over a computer network such as the Internet; use on personal computers, tablets, smart phones, and other devices; touch screen or voice-interface feature for devices that support such a feature; editing features that encompass both functional and non-functional features of the technology known as celeration charting.

The description of illustrated embodiments, including the description in the Abstract, is not exhaustive nor shall it limit the invention to only those embodiments, depictions, or descriptions disclosed. Those skilled in the celeration charting will recognize that many relevant features are not discussed herein, but are assumed. The scope of the invention is covered herein, with the expectation that necessary modifications will be needed to operate and accept advances in the relevant field.

1. An electronic/digital application to teach celeration charting across all typical and accepted celeration charts, and a tool for continual data collection and analyses on celeration charts. The application is designed to measure speed and accuracy (fluency) of those learning celeration charting as well as to produce a report and certification of said fluency and training. Exact criteria for fluency may be modified to suit the needs of individual users and/or organizations. Personalization of charts within this application will afford users with means for tailoring the chart and ease of charting to the specific needs of individual users or organizations.
The celeration charts of claim 1 will encompass all standard celeration charts that are common to the field of Behavior Analysis and the Standard Celeration Society, as well as those standard celeration charts informally adopted by individuals and organizations. Standard celeration charts utilize a logarithmic scale for the measure of rate of responding.
The continual data collection and analyses on celeration charts of claim 1 wherein users of this tool and technology may opt to store, access, share, analyze their data collection and charts remotely via electronic media such as the Internet or other communication networks.
The measure of fluency for learners of celeration charting in claim 1 wherein the same technology of celeration charting will be used to assess the accuracy and speed as well as competence of celeration charting as those learners progress through the application designed for teaching celeration charting.
The teaching of claim 4 may incorporate the use of progress feedback and prompts for the correct responding for the specific learning/teaching topic, module, or during the course of regular chart use outside of the training modules. Teaching may also refer to the usability of this technology in educational settings, or other settings—which afford instructors or others certain features for assuring learner fluency and verification of original work products.
The report and/or certification of claim 1 will identify the fluency performance(s) made in claim 4 and produce proof of completion of the training portion of this application.
The measure of learner celeration charting fluency of claim 1, claim 4, and claim 5 may be changed by individuals or organizations to suit the specific criteria by which the learner is intended to meet.
Personalization of charts of claim 1 refers to two types: charting tool features personalization (i.e., functional feature), and artistic personalization (i.e., non-functional features).
Charting tool features personalization of claim 8 refers to the modifiability of the functional features of the charting tool, such as timing and type of data collected, automatic calculations from timing sheets to other related data collection sheets, automatic calculations for patterns or trends in responding that correlate to dates or other relevant benchmarks, collapsing of axes toward axes names or legend for accurate placement of collected data.
Artistic personalization of claim 8 refers to the modifiability of the non-functional features of the charting application such as the font type, text or other graphic location, editing of title or other heading, the viewing window of the chart, symbol editing, classic “pencil-and-paper”look or a digital presentation (i.e., perfect lines, circles, and text), and other similar feature modifications.
